(19) United States
(12) Patent Application Publication
(10) Pub. No.: US 2011/0142107 A1
(43) Pub. Date: Jun. 16, 2011

(54) Rank Adaptive Cyclic Shift for Demodulation Reference Signal

(76) Inventors: Kyle Jung-Lin Pan, Smithtown, NY (US); Allan Tsai, Boonton, NJ (US); Robert Olesen, Huntington, NY (US); Sung-Hyuk Shin, Northvale, NJ (US)

(21) Appl. No.: 12/813,594

(22) Filed: Jun. 11, 2010

Related U.S. Application Data
(60) Provisional application No. 61/187,473, filed on Jun. 16, 2009.

(51) Int. Cl. H04B 17/00; H04B 1/38

(52) U.S. Cl. 375/219; 375/224

(57) ABSTRACT

Systems and methods for generating a demodulation reference signal for use by user equipment configured with multiple antennas based on a rank of an antenna or an antenna port are disclosed. A rank for a user equipment device is determined indicating the number of spatial layers or antenna ports in use, and the value of the rank is used to generate a cyclic shift offset and a cyclic shift, that can then be used to generate a demodulation reference signal to be used in timeslots within each spatial layer of an uplink transmission. Orthogonal cover codes may be used in conjunction with a determined cyclic shift to generate a demodulation reference signal.

### CROSS-REFERENCE TO RELATED APPLICATION

This applications claims the benefit of U.S. Provisional Application No. 61/187,473, filed Jun. 16, 2009, which is hereby incorporated by reference in its entirety.

### BACKGROUND

The Third Generation Partnership Project (3GPP) Long Term Evolution (LTE) standards provide specifications for high performance air interfaces for cellular mobile communication systems. LTE specifications are based on Global System for Mobile Communications (GSM) specifications, and provide the upgrade path for 3G networks to evolve into partially-compliant 4G networks. LTE Advanced (LTE release 10) is an enhancement of the LTE standard that provides a fully-compliant 4G upgrade path for LTE and 3G networks.

A user device or user equipment (UE) in an LTE system, such as a mobile telephone or smart phone, typically will transmit uplink data on a limited, contiguous set of assigned sub-carriers in an FDMA arrangement. This is known as single-carrier frequency-division multiple access (SC-FDMA), which may also be known as discrete Fourier transform spread orthogonal frequency division multiple access (DFT-S-OFDMA). By using this technology, lower peak-to-average power ratios compared to OFDMA transmission technology may be achieved. For example, if the overall signal or system bandwidth available for an uplink is composed of sub-carriers numbered 1 to 100, a first UE may be assigned to transmit its own signal on sub-carriers 1-12, a second UE may transmit on sub-carriers 13-24, and so on. A network node such as a base station, also referred to as an eNodeB in an LTE system, may receive the composite uplink signal across the entire transmission bandwidth from several UEs in the same time, but each UE would transmit into a subset of the available transmission bandwidth.

To improve uplink data transmission rates, LTE Advanced supports carrier aggregation and flexible bandwidth arrangements. For example, in LTE Advanced, unlike in LTE, uplink and downlink bandwidths may be asymmetric (e.g., 10 MHz for downlink and 5 MHz for uplink.) LTE Advanced also supports composite aggregate transmission bandwidths (e.g., a first 20 MHz downlink carrier and a second 10 MHz downlink carrier paired with a single 20 MHz uplink carrier.) Such composite aggregate transmission bandwidths may, but need not, be contiguous in the frequency domain. Moreover, while LTE (release 8) supports using a single transmit antenna, and therefore transmission over a single layer, LTE Advanced supports up to four antennas, and therefore up to a rank four or four layer transmission. This allows LTE Advanced networks and devices to implement Multiple Input and Multiple Output (MIMO) technologies, where multiple antennas may be used at both the transmitter and the receiver. What are needed in the art are methods and systems for demodulating MIMO uplink transmissions.

### SUMMARY

Systems and methods for generating a demodulation reference signal for uplink transmissions are disclosed. The present systems and methods may be implemented by user equipment configured with multiple antennas for transmitting multiple signals, for example using MIMO technology. A demodulation reference signal (RS) at a UE may be generated based on a rank of a channel or a rank of transmission (e.g., number of layers for transmission) through which the RS is transmitted. In an embodiment, a channel (or transmission) rank indication (RI) may be received at a UE from a base station, such as an eNodeB. A rank indication (RI) may be signaled to the UE either by separate signaling, embedded in other control information or signal, or jointly coded with other control information such as transmission precoding matrix indication. The received RI or determined rank may then be used to generate a cyclic shift (CS) offset, which may then be used to generate a CS. The generated cyclic shift may then be used to generate a demodulation reference signal to be used for uplink MIMO transmissions by the UE. Orthogonal Cover Codes (OCC) may be used in conjunction with a determined CS to generate a DeModulation Reference Signal (DM-RS). These and additional aspects of the current disclosure are set forth in more detail below.

### BRIEF DESCRIPTION OF THE DRAWINGS

The following detailed description of disclosed embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 illustrates a non-limiting exemplary user equipment on which rank adaptive cyclic shift determinations for generating demodulation reference signals as disclosed herein may be implemented.

FIG. 2 illustrates non-limiting exemplary network environment in which adaptive cyclic shift determinations for generating demodulation reference signals as disclosed herein may be implemented.

FIG. 3 illustrates a non-limiting exemplary subframe spatial layer including two time slots and generated demodulation reference symbols.

FIG. 4 illustrates non-limiting exemplary subframe spatial layers, each including two time slots and generated demodulation reference symbols.

FIG. 5 illustrates non-limiting exemplary subframe spatial layers, each including two timeslots and generated demodulation reference symbols.

FIG. 6 illustrates a non-limiting exemplary method of performing demodulation reference signal generation.

### DETAILED DESCRIPTION OF ILLUSTRATIVE EMBODIMENTS

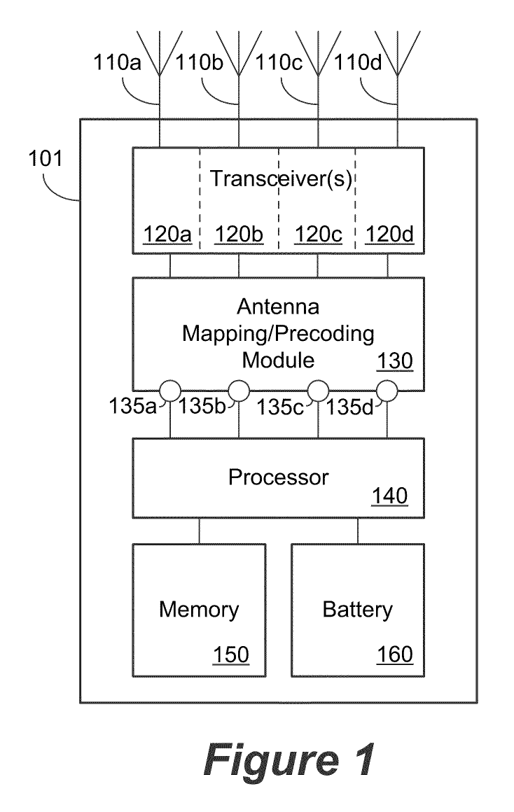

FIG. 1 illustrates non-limiting, exemplary UE 101 that may implement MIMO and other features of LTE Advanced. UE 101 may be a wireless transmit and receive unit (WTRU) of any type, including a mobile telephone, a smart phone, a personal data assistant (PDA), a laptop, or any other device that may wirelessly communicate with one or more other devices or networks. In some embodiments, UE 101 may be configured to communicate with an LTE Advanced network. UE 101 may be configured with processor 140, which may be communicatively connected with memory 150 and may draw power from a power source, such as battery 160, which may also provide power to any or all of the other components of UE 101. Processor 140 may be configured to perform rank adaptive demodulation and related functions as disclosed herein, as well as any other functions disclosed herein and/or any other functions that may be performed by a processor configured in a UE. Memory 150 may be configured to store data, including computer executable instructions to perform any function described herein or any other function that may be performed by a UE. UE 101 may also be configured with one or more antennas 110a-d, which may transmit data received from one or more transceivers 120a-d to a base station, eNodeB, or other network device, and may provide data from such a device to one or more transceivers 120a-d.

Transceivers 120a-d and/or antennas 110a-d may be communicatively connected to antenna mapping/precoding module 130. Antenna mapping/precoding module 130 may be communicatively connected to processor 140, in an embodiment via demodulation reference signal (DM-RS) antenna ports 135a-d. Note that any or all of the components illustrated in FIG. 1 may be physically the same component or combined into a single physical unit, or alternatively may be physically separate. For example, antenna mapping/precoding module 130, processor 140, and transceivers 120a-d may be physically configured on a single microchip, or may each be configured on individual microchips. Any variations of such configurations are contemplated as within the scope of the present disclosure.

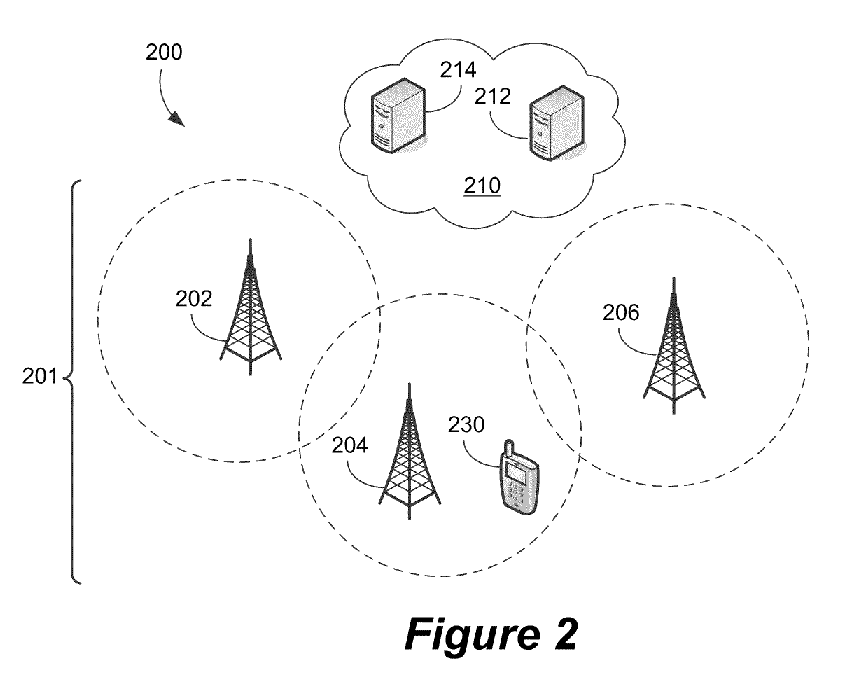

FIG. 2 illustrates a non-limiting, exemplary wireless communications system 200 that may be an LTE system. Communications system 200 may include Evolved-Universal Terrestrial Radio Access Network (E-UTRAN) 201 which may provide an air interface and wireless access to an LTE system. UE 230 may communicate with E-UTRAN 201 via one or more of base stations 202, 204, and 206, which may be any type of base stations, including evolved Node Bs, (eNodeBs.) Base stations 202, 204, and 206 may be configured to communicate with each other and may also be configured to communicate with network 210, which may be part of an LTE system. Network 210 may include devices 212 and 214, which may be Mobility Management Entities (MMES) and/or Serving Gateways (S-GW).

Each of base stations 202, 204, and 206 and devices 212 and 214 may be configured with one or more processors, power supplies, memories, disks, other data storage devices, and any other components that may be implemented in such devices, and may be configured to perform any of the functions described herein as well as any of the functions of a communications system, including an LTE or an LTE Advanced system. Moreover, data storage devices may be configured on base stations 202, 204, and 206 and devices 212 and 214 to contain computer executable instructions to perform any of the functions described herein as well as any of the functions of a communications system, including an LTE or an LTE Advanced system. While a single UE and selected components of a wireless communications system are illustrated in FIG. 2, any types and numbers of components and UEs may be used and/or configured in communications system 200, and all such embodiments are contemplated as within the scope of the present disclosure.

In an LTE Advanced system, mechanisms that allow increased bandwidth and transmission extensions are supported, such as uplink multiple antenna transmission and uplink MIMO, for example using two or more of antennas 110a-d configured in UE 101 in FIG. 1. To perform uplink MIMO, demodulation reference signals (DM-RS) and cyclic shift may be generated for each DM-RS antenna port in use, such as DM-RS antenna ports 135a-d configured in UE 101 in FIG. 1. Each DM-RS antenna port may be mapped to a physical antenna, a spatial layer, or a general physical antenna mapping such as precoding to antennas 110a-d configured in UE 101 in FIG. 1. Each DM-RS antenna port may be associated with or labeled to a spatial layer for a particular RI or number of layers for transmission. For example, DM-RS antenna port 135a may be associated with the first layer, DM-RS antenna port 135b may be associated with the second layer, etc.

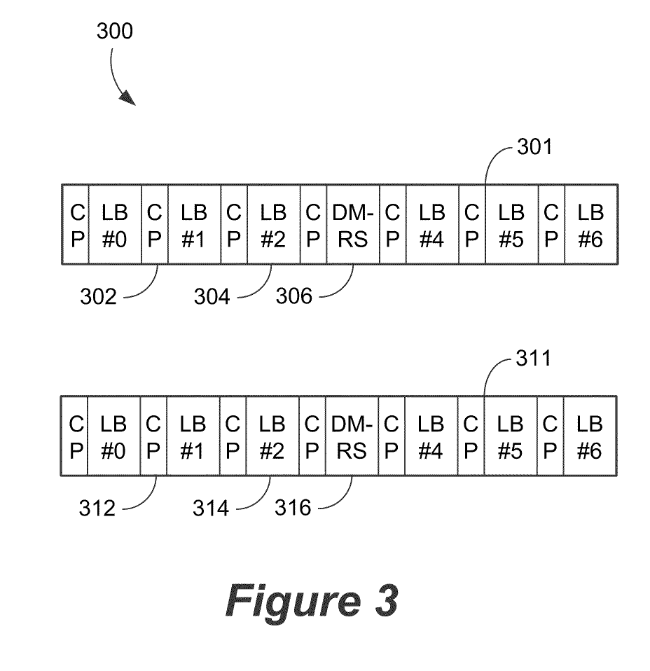

DM-RSs within an uplink transmission from a UE may be used by a base station, such as an eNodeB, to accurately estimate the channel, or channel responses, on which uplink data is being transmitted by identifying the known DM-RSs and determining the associated channel. For example, as seen in FIG. 3 illustrating subframe 300 containing two timeslots 301 and 311, DM-RS 306 may be transmitted within timeslots 301 and 311 along with cyclic prefixes 302 and 312 and data contained in long blocks 304, 314, etc. In an LTE Advanced or similar system with UEs configured to implement MIMO, two or more UE antennas may be used to transmit uplink data from a single UE. However, because a UE may be required to transmit data on one or more specific sub-carriers and antennas or layers, using the same DM-RS in each transmitted subframe may cause problems because the DM-RSs may interfere with each other. Thus transmissions for each antenna, antenna port, or layer may be assigned its own DM-RS, or a shifted version of a base DM-RS, using the methods and system described herein, to prevent such interference and other issues. DM-RS may be precoded or beamformed using a precoding vector, matrix, or antenna weights. For example, for a number of receive antennas denoted as R, a number of transmit antennas denoted N, and a number of spatial layers denoted M, the received signal Y at the lth OFDM symbol and subcarrier k may be expressed as:

$$[ \begin{matrix}{Y}_{1} [ l , k ] \\ {Y}_{2} [ l , k ] \\ ⋮ \\ {Y}_{R} [ l , k ]\end{matrix} ] = [ \begin{matrix}{H}_{1 , 1} [ l , k ] & … & {H}_{1 , N} [ l , k ] \\ {H}_{2 , 1} [ l , k ] & … & {H}_{2 , N} [ l , k ] \\ ⋮ & ⋮ & ⋮ \\ {H}_{R , 1} [ l , k ] & … & {H}_{M , N} [ l , k ]\end{matrix} ] [ \begin{matrix}{P}_{1 , 1} [ l , k ] & … & {P}_{1 , M} [ l , k ] \\ {P}_{2 , 1} [ l , k ] & … & {P}_{2 , M} [ l , k ] \\ ⋮ & ⋮ & ⋮ \\ {P}_{N , 1} [ l , k ] & … & {P}_{N , M} [ l , k ]\end{matrix} ] [ \begin{matrix}{S}_{1 , 1} [ l , k ] \\ ⋮ \\ {S}_{M , 2} [ l , k ]\end{matrix} ] + [ \begin{matrix}{N}_{1} [ l , k ] \\ {N}_{2} [ l , k ] \\ ⋮ \\ {N}_{R} [ l , k ]\end{matrix} ] , \\ Y = HPS + N$$

where H is the channel matrix with row size R (note that, in one embodiment, R=M) and column size N, P is the precoding or beamforming matrix with row size N and column size M where M<=N, (note that when M=N, the precoding matrix may not be needed), S is the DM-RS symbols or sequences at the lth OFDM symbol and subcarrier k, and N is the noise vector. Hence, multiplexing M DM-RS between spatial layers, antenna ports, and/or transmit antennas may be required.

Multiplexing DM-RSs between different spatial layers, antenna ports, and/or transmit antennas may be accomplished using code division multiplexing (CDM). For example, cyclic shift separation or cyclic shift in combination with cover code (CC) or orthogonal cover code (OCC) separation may be used to increase the number of DM-RS sequences that are available for UL-MIMO or to enhance the orthogonality or properties of DM-RSs, for example, in terms of auto-correlation and/or cross-correlation of them. For example, if Q cyclic-shift (CS) codes are available, then CC or OCC could be [+1, +1] and [+1, −1] for two-layer, or rank two (e.g., M=2) transmission. In this way, there may be 2 times Q orthogonal DM-RS codes available for spatial multiplexing, thereby increasing the DM-RS multiplexing gain. Alternatively, Q CSs may be used as the primary spatial multiplexing scheme and CC or OCC may be used as a complementary multiplexing scheme. In such embodiments, the spatial multiplexing degree is Q which is the number of CSs available, while utilizing CCs or OCCs on top of the CSs may improve the orthogonal property of DM-RSs. Depending on the antenna configuration, in other embodiments precoded or beamformed DM-RSs may be used. For example for UEs having or configured with two transmit antennas (N=2) and a single spatial layer (M=1), transmission may use a precoded or beamformed DM-RS, while two-layer (dual-layer) transmission may use non-precoded DM-RS or antenna-specific DM-RS. For UEs having or configured with four transmit antennas (N=4), a single-layer (M=1), dual-layer (M=2), or three-layer (M=3) transmission may use a precoded or beamformed DM-RS, while four-layer transmission may use non-precoded DM-RS or antenna-specific DM-RS. Other embodiments may use precoded or beamformed DM-RS for dual-layer transmission for UEs with a two transmit antenna configuration, and for four-layer transmission for UEs with a four transmit antenna configuration.

There are several ways that the cyclic shift may be indicated in uplink MIMO. In an embodiment, a first cyclic shift may be signaled and used as a reference and the other cyclic shifts may be implicitly (e.g., according to a predefined rule or mappings) derived from the first cyclic shift. In a single layer transmission embodiment, the cyclic shift may be signaled in a physical downlink control channel (PDCCH) by a base station, such as an eNodeB. For dual-layer or more the cyclic shift for one of the layers (e.g., the first layer transmission using e.g., antenna port 0) may be signaled in a PDCCH by an eNodeB, while the cyclic shift for the other layers (e.g., the second layer transmission using e.g., antenna port 1 and higher layers e.g., the third layer using e.g., antenna port 2, etc.) may be derived from the first cyclic shift that is signaled via the PDCCH. The first cyclic shift (that is signaled) may serve as a “reference cyclic shift” which may be explicitly signaled via PDCCH and may be used to derive the remaining cyclic shifts. Alternatively, the reference cyclic shift may be provided by an eNodeB via higher layer signaling (e.g., RRC signaling), media access control (MAC) layer signaling (e.g., MAC control element (MAC CE)), or a combination of physical layer signaling (e.g., PDCCH) and higher layer signaling.

In addition, orthogonal cover codes may be used in combination with the cyclic shift codes for DM-RS. In such embodiments, the first combination of cyclic shift and orthogonal cover code may be signaled (e.g., via PDCCH) and may be used as a “reference cyclic shift and orthogonal cover code” to derive the other combinations of cyclic shifts and orthogonal cover codes. A predetermined OCC may be used for the reference CS and OCC. For example, OCC=[+1 +1] (or corresponding OCC index) may be a default OCC for the reference CS/OCC (or reference CS/OCC index). Alternatively, OCC=[1 +1 −1] (or corresponding OCC index) may be a default OCC for the reference CS/OCC (or reference CS/OCC index.) The remaining CS(s)/OCC(s) (or CS/OCC index(es)) may be derived from the “reference CS/OCC” using, for example, equations or mappings between the “reference CS/OCC” and the remaining CS/OCC. Examples are illustrated herein in Tables 1, 2, 3, and 4. Alternatively, for a given CS, an associated OCC (or OCC index) may be determined as a function of the CS (or CS index) such as OCCₘ=f(CSₘ) where OCCₘ and CSₘ are the OCC (or OCC index) and CS (or CS index), respectively, for DM-RS antenna port m. For example, the OCC index OCCₘ may be determined as OCCₘ=mod(CSₘ, 2) where “mod(x, 2)=x mod(2)” represents the modular-2 arithmetic of x such as OCCₘ=mod(CSₘ,2)=0 if CSₘ has an even index number, otherwise OCCₘ=mod(CSₘ,2)=1, where e.g., the OCC index “0” may correspond to OCC=[+1 +1], while “1” may correspond to OCC=[+1 −1] or vice versa. Alternatively, a mapping/configurable table(s) for CS/OCC combinations for each rank (or number of DM-RS antenna ports) may be provided for each UE by the eNodeB via higher layer signaling (e.g., RRC signaling). In this embodiment, upon receiving a RI from PDCCH, the UE may use the mapping/configuration table associated with the received rank to link a CS/OCC combination to each DM-RS.

Alternatively, an optimum cyclic shift offset may be obtained using the following equation:

$$γ = \frac{{N}_{cs}}{M} , \qquad ( 1 )$$

where M={1, 2, 3, 4} may be the rank indication (RI) signaled by an eNodeB and, for example, N_{CS}=12 may be the maximum cyclic shift. Hence, for each DM-RS port (e.g., m=1, . . . , M−1 for antenna port 1, . . . , M−1), cyclic shift offset is incremented by Y. By using this method, the optimum cyclic shift offset values may be determined and assigned according to an adaptive rank or rank adaptation. Once a RI is obtained, or the rank is determined, the corresponding DM-RS or its index or cyclic shift/orthogonal cover code (CS/OCC) or its index may be obtained. If the cyclic shift offset for the first (or reference) DM-RS antenna port (i.e., the first spatial layer) is denoted by CS₀, 0≦CS₀≦N_{CS}−1, for additional DM-RS ports (i.e., additional spatial layer), then the cyclic shift may be determined by the following:

(CSₘ=(CS₀+m×y)mod(N_{CS}), m=1, . . . , M−1. (2)

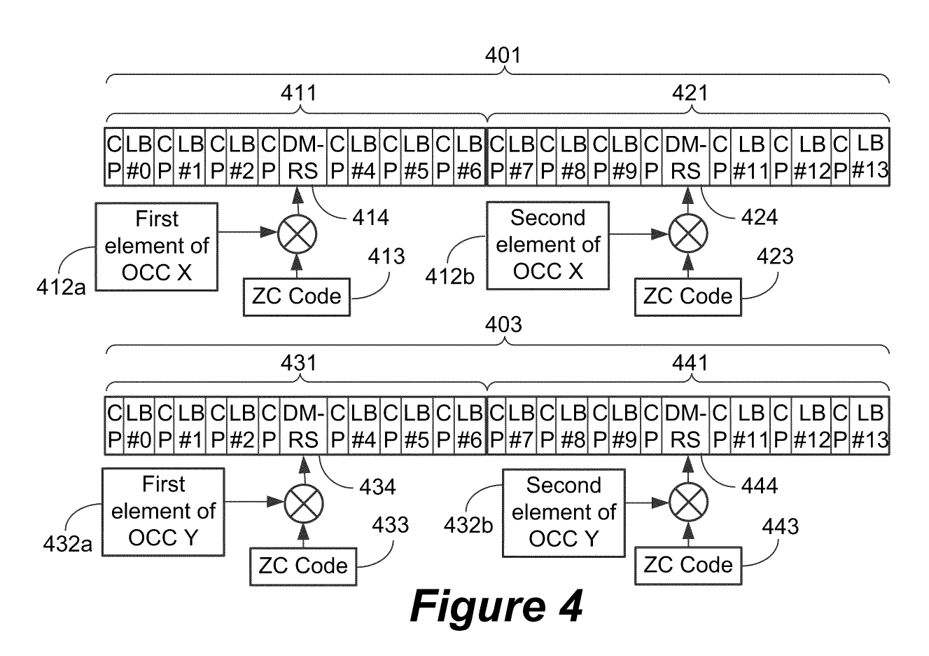

Since other CSs can be derived from the first (reference) CS or CS₀ which may be signaled (e.g., via PDCCH), by using this method, additional dynamic explicit signaling for other CSs or Csₘ may not be necessary. Note that equations 1 and 2 shown herein are example equations to derive CS from the first (reference) CS which is signaled. If CS₀ is not signaled from PDCCH, then the value of CS₀ may be set to zero and other CS(s) may be derived accordingly. From equation 1 and 2, for a given RI the differences/offsets between different CSs (for different DM-RM antenna ports) are of maximum uniform space, which may provide the performance of DM-RS transmission in an optimal way. Other variants or modifications of equations 1 and 2 are also possible and are contemplated as within the scope of the present disclosure. Fixed mappings that define other CSs without using equations are also possible. Examples are illustrated herein in Tables 1, 2, 3 and 4. If OCC is used, OCC or OCC index may be directly derived from the associated CS or CS index, for example, using one of the methods mentioned above. Alternatively, OCC patterns may be configured via higher layer signaling for each rank or predefined per rank, for example, OCC=[+1 +1] [+1 −1] for rank 2, OCC=[+1 +1] [+1 +1] [+1 −1] for rank 3, OCC=[+1 +1] [+1 +1] [+1 −1] [+1 −1] for rank 4. Each of DM-RSs 414, 424, 434, and 444 of FIG. 4 may be generated using these methods.

A similar method may be used when a combination of CS and orthogonal cover code (OCC) is used to generate DM-RSs. OCCs may be linked to reserved CS resources or index, or Rank Indications (RI). By using this method, additional dynamic signaling due to use of OCCs is not necessary if the OCCs are configured and linked to CS indices and/or a RI. If an OCC is used, the optimal CS offset may obtained using the following equation which is a modified version of equation (1) above:

$$γ = \frac{{N}_{cs}}{⌈ M / 2 ⌉} . \qquad ( 3 )$$

In this case, equation (2) shown above may be modified as follows to generate and derive other cyclic shifts based on the first (reference) cyclic shift that is signaled, for example via PDCCH:

CSₘ=(CS₀+└m/2┘×y)mod(N_{CS}), m=1, . . . , M−1. (4)

Examples are shown in Tables 1, 2 and 3 below. Note that although other CSs may be determined or derived from the first (reference) CS using equations 3 and 4, other variants or modifications of equations 3 and 4 may also be used. For example, even though OCC is used for DM-RS transmission, the optimal CS offset may be determined or obtained using equation (1) and equation (2) rather than using equation (3) and equation (4), as mentioned above. Fixed mappings that define other CS or CS/OCC combinations without using such equations are also possible. In an embodiment, the first CS may be zero or CS₀=0. Note that the first CS or CS₀ may be signaled and may be any other value, for example, 0<=CS₀<=N_{CS}−1. Using equations 1 and 2 with OCC linked to CS (or as a function of CS) may generate the following CS:

CS₀=0, OCC₀=[1 1] 1st CS/OCC

CS₁=CS₁+6, OCC₁=[1 1] 2^{nd} CS/OCC

or

CS₀=0, OCC₀=[1 1] 1st CS/OCC

CS₁=CS₀+6, OCC₁=[1 −1] 2^{nd} CS/OCC

where OCCᵢ is linked to CSᵢ where i=0,1 for rank-2 transmission. For example OCC₀=[1 1] is linked to CS₀=0 and OCC₁=[1 1] or [1 −1] is linked to CS₁=6 which may be predetermined or configurable. The latter case introduces additional OCC (OCC=[1 −1]) in addition to additional CS for the second spatial layer or DM-RS antenna port can provide enhanced orthogonality for DM-RS multiplexing. This results in CS/OCC combination for 1^{st} and 2^{nd} CS/OCC, an example of which is shown in Table 1. Alternatively:

CS₀=0, OCC₀=[1 −1] 1st CS/OCC

CS₁=CS₀+6, OCC₁=[1 −1] or [1 1] 2^{nd} CS/OCC

Another possibility using equations 3 and 4 with OCC linked to CS (or as a function of CS) is shown in the following is shown in the following:

CS₀=0, OCC₀=[1 1] 1st CS/OCC

CS₁=CS₀, OCC₁=[1 −1] 2^{nd} CS/OCC

In this case the separation between DM-RS relies on OCC only, not on CS. This is also shown in Table 1. Alternatively,

CS₀=0, OCC₀=[1 −1] 1st CS/OCC

CS₁=CS₀CS₀+, OCC₁=[1 1] 2^{nd} CS/OCC

In this embodiment, each DM-RS used for each layer or antenna port may be cyclically shifted and coded using the derived cover codes and may be transmitted in a subframe. Thus, DM-RSs for a subframe can be generated as shown in FIG. 4. FIG. 4 illustrates spatial layer 401 containing timeslots 411 and 421 and spatial layer 403 containing timeslots 431 and 441 in a subframe. Note that signals and/or data in spatial layers 401 and 403 may be transmitted in the same subframe. Each of spatial layers 401 and 403 in a subframe may contain uplink data transmitted on different antennas or antenna ports of the same UE. For example, for rank 2 transmission, spatial layer 401 may be transmitted by a first antenna or a first spatial layer, while spatial layer 403 may be transmitted by a second antenna or a second spatial layer in the same subframe. In an embodiment, each DM-RS may be generated using a Zadoff-Chu (ZC) sequence or code. Thus, ZC Codes 413 and 423 may be used to generate the base DM-RSs used in timeslots 411 and 421, and ZC Codes 433 and 443 may be used to generate the base DM-RSs used in timeslots 431 and 441. Note that in many embodiments, ZC Codes 413 and 423 may be the same, as may be ZC codes 433 and 443. In some embodiments, all four ZC codes (413, 423, 433, and 443) may be the same. In some embodiments where OCC code is turned off or not used or the same OCC (e.g., [1 1] or [1 −1]) is applied for all spatial layers, ZC Codes 413 and 423 may be different than ZC codes 433 and 443. ZC Codes 413 and 423 may be cyclic shifted versions of ZC Codes 433 and 443, or vice versa.

The DM-RSs may also be generated using the orthogonal cover code (OCC). For example, DM-RS 414 may be generated using the first element of OCC X 412a and DM-RS 424 may be generated using the second element of OCC X 412b. OCC X may be an OCC determined or derived for spatial layer 401, examples of which are described throughout the present disclosure (e.g., [1 1], [1 −1], etc.) Likewise, DM-RS 434 may be generated using the first element of OCC Y 432a and DM-RS 444 may be generated using the second element of OCC Y 432b. OCC Y may be an OCC determined or derived for spatial layer 403, examples of which are described throughout the present disclosure (e.g., [1 1], [1 −1], etc.) Note that, while two timeslots for each spatial layer are shown, more timeslots and multiple spatial layers associated with additional antennas configured on a single UE may be generated.

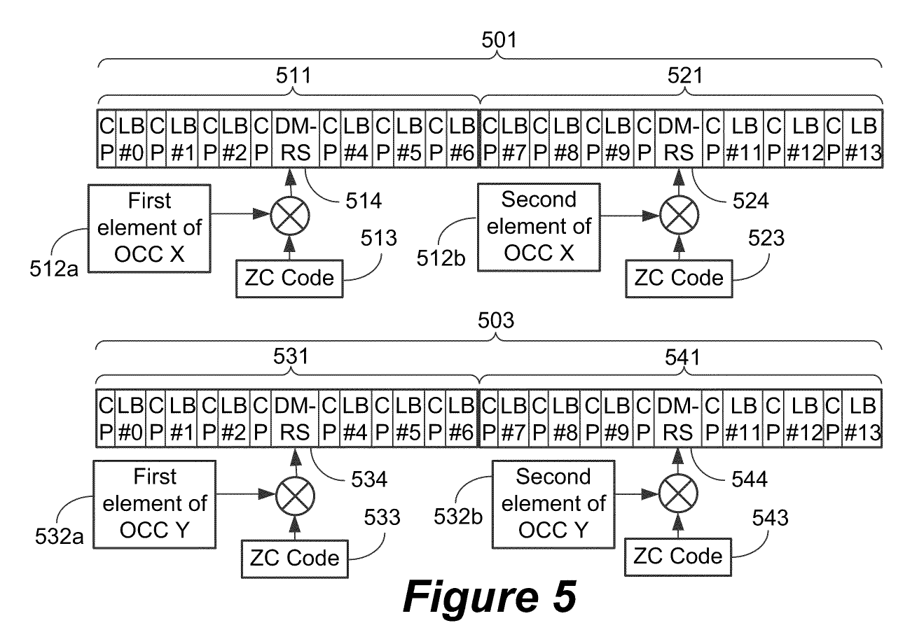

In another embodiment, the DM-RS used in each timeslot of a spatial layer transmitted by two or more UE antennas may be cyclically shifted. Thus, the DM-RSs for each timeslot can be generated as shown in FIG. 5. FIG. 5 illustrates timeslots 511 and 521 of spatial layer 501 and timeslots 531 and 541 of spatial layer 503. Note that signals and/or data in spatial layers 501 and 503 may be transmitted in the same subframe. Each spatial layer 501 and 503 may contain uplink data transmitted on different antennas or antenna ports of the same UE. For example, for rank 2 transmission, spatial layer 501 containing timeslot 511 and timeslot 521 may be a spatial layer transmission transmitted by a first antenna, or a first spatial layer, and spatial layer 503 containing timeslots 531 and timeslot 541 may be a spatial layer transmission transmitted by a second antenna, or a second spatial layer. In an embodiment, each DM-RS may be generated for each timeslot of a spatial layer using a Zadoff-Chu (ZC) sequence or code. Thus, ZC Code 513 may be used to generate the base DM-RS used in timeslot 511 and ZC Code 523 may be used to generate the base DM-RS used in timeslot 521, while ZC Code 533 may be used to generate the base DM-RS used in timeslot 531 and ZC Code 543 may be used to generate the base DM-RS used in timeslot 541. This implies enabling sequence group hopping in time (e.g., on a timeslot basis). ZC Code 523 may be a cyclic shifted version of ZC Code 513 or vice versa, and ZC Code 543 may be a cyclic shifted version of ZC Code 533 or vice versa.

In this embodiment, the DM-RS may be generated by turning off the OCC Codes 512, 522, 532, and 542. Alternatively, a (same) reference OCC code (e.g., [1 1] or [1 −1]) may be applied for all spatial layers (i.e., DM-RS antenna ports). In one embodiment, DM-RS 514 may be generated using the first element of OCC X 512a and DM-RS 524 may be generated using the second element of OCC X 512b. OCC X may be an OCC determined or derived for spatial layer 501, examples of which are described throughout the present disclosure (e.g., [1 1], [1 −1], etc.) Likewise, DM-RS 534 may be generated using the first element of OCC Y 532a and DM-RS 544 may be generated using the second element of OCC Y 532b. OCC Y may be an OCC determined or derived for spatial layer 503, examples of which are described throughout the present disclosure (e.g., [1 1], [1 −1], etc.) Note that, while two timeslots for each spatial layer are shown, more timeslots and multiple spatial layers associated with additional antennas configured on a single UE may be generated.

In another embodiment, remapping or reconfiguration of CS/OCC combinations may be applied at the boundary of a timeslot, subframe, or radio frame in order to randomize the CS/OCC combinations between different DM-RS antenna ports for a UE. For example, a reference CS/OCC combination (e.g., CS₀ for the reference CS and/or associated/linked OCC for the first spatial layer (DM-RS antenna port)) may vary according to a predefined manner, such as varying as a function of the subframe number/index (or frame number or timeslot number), for example, using reference CS/OCC combination-1(e.g., CS₀=0, OCC=[+1 +1]) for an even subframe number/index and reference CS/OCC combination-2(e.g., CS₀=2, OCC=[+1 +1] or [+1 −1]) for an odd subframe number index. The remaining CS/OCC combinations for other spatial layers (DM-RS antenna ports) may be remapped/reconfigured accordingly (e.g., according to one of the methods described above.)

Thus the methods described above can be used to generate DM-RSs that are rank adaptive in that once a RI is obtained, or a rank is determined, a corresponding DM-RS or its index, or CS/OCC combination or combination index, for each spatial layer may be determined. For example, if a dual-layer transmission is used by a UE, its associated DM-RS index may be determined to be 0 and 1 for the first and second layer transmission respectively. The corresponding CS/OCC combinations or mappings may be the following: the first spatial layer transmission may use CS₀=0, OCC=[1 1] for DM-RS and the second spatial layer transmission may use and CS₁=0, OCC=[1 −1] for DM-RS. In another embodiment, the first layer transmission may use CS₀=0, OCC=[1 1] for DM-RS and the second layer transmission may use CS₁=12/2=6, OCC=[1 1] or [1 −1] for DM-RS, as shown in Table 1. The first CS or CS/OCC may be signaled (for example, via PDCCH) i.e., CS₀(e.g., CS₀=0, OCC=[1 1]) may be signaled or the index associated with it (e.g., DM-RS index=0) may be signaled. The second CS/OCC may be derived or mapped based on the first CS/OCC (the reference CS/OCC) as shown in Table 1. The second CS/OCC may be derived from the reference CS/OCC that is signaled and may have the following possible mappings or associations:
(i) CS₁=CS₀+6(e.g., CS₁=6) and OCC=[1 1] (e.g., use equations 1 and 2 and link OCC=[1 1] with CS₁=6)
(ii) CS₁=CS₀+6(e.g., CS₁=6) and OCC=[1 −1] (e.g., use equations 1 and 2 and link OCC=[1 −1] with CS₁=6)
(iii) CS₁=CS₀(e.g., CS₁=0) and OCC=[1 −1] (e.g., use equations 3 and 4 and link OCC=[1 −1] with CS₁=0)
   The mapping for CS and/or linking for CS and OCC may be predetermined or configurable. For example, mapping (i) may be predetermined and used as a fixed mapping with respect to the first or reference CS/OCC. Alternatively, one of the mappings may be selected and configured by the eNodeB.

TABLE 1
CS resources with OCC code assignments for two
layer transmission (rank = 2)

| DM-RS Index | CS | OCC |
|---|---|---|
| 0 | 0 | [1 1] |
| 1 | 0/6 | [1 −1]/[1 1] |

Similarly, if four layer transmission is used by the UE, the associated DM-RS index may be determined to be one of the following associations for the first, second, third and forth layer respectively:
(i) DM-RS Index=0: CS₀(e.g., CS₀=0), OCC=[1 1],
DM-RS Index=1: CS₁=CS₀+3(e.g., CS₁=3), OCC=[1 1],
DM-RS Index=2: CS₂=CS₀+6(e.g., CS₂=6), OCC=[1 1], and
DM-RS Index=3: CS₃=CS₀+9(e.g., CS₃=9), OCC=[1 1]
or
DM-RS Index=0: CS₀(e.g., CS₀=0), OCC=[1 −1]
DM-RS Index=1: CS₁=CS₀+3(e.g., CS₁=3), OCC=[1 −1],
DM-RS Index=2: CS₂=CS₀+6(e.g., CS₂=6), OCC=[1 −1], and
DM-RS Index=3: CS₃=CS₀+9(e.g., CS₃=9), OCC=[1 −1]
for the first, second, third, and fourth layer respectively, in one example.
(ii) DM-RS Index=0: CS₀(e.g., CS₀=0), OCC=[1 1],
DM-RS Index=1: CS₁=CS₀+3, OCC=[1 −1],
DM-RS Index=2: CS₂=CS₀+6, OCC=[1 1], and
DM-RS Index=3: CS₃=CS₀+9, OCC=[1 −1]
or
DM-RS Index=0: CS₀(e.g., CS₀=0), OCC=[1 −1],
DM-RS Index=1: CS₁=CS₀+3, OCC=[1 1],
DM-RS Index=2: CS₂=CS₀+6, OCC=[1 −1], and
DM-RS Index=3: CS₃=CS₀+9, OCC=[1 1],
for the first, second, third, and fourth layer respectively, in another example.
(iii) DM-RS Index=0: CS₀(e.g., CS₀=0), OCC=[1 1],
DM-RS Index=1: CS₁=CS₀, OCC=[1 −1],
DM-RS Index=2: CS₂=CS₀+6, OCC=[1 1], and
DM-RS Index=3: CS₃=CS₀+6, OCC=[1 −1]
or
DM-RS Index=0: CS₀(e.g., CS₀=0), OCC=[1 −1],
DM-RS Index=1: CS₁=CS₀, OCC=[1 1],
DM-RS Index=2: CS₂=CS₀+6, OCC=[1 −1], and
DM-RS Index=3: CS₃=CS₀+6, OCC=[1 1],
for the first, second, third, and fourth layer respectively, in yet another example.
   This is also illustrated in Table 2 shown below. Note that other mappings or combinations are also possible and contemplated as within the scope of the present disclosure.

TABLE 2
CS resources with OCC code assignments for four
layer transmission (rank = 4)

| DM-RS Index | CS | OCC |
|---|---|---|
| 0 | 0 | [1 1] |
| 1 | 0/3 | [1 −1]/[1 1] |
| 2 | 6 | [1 1]/[1 1] |
| 3 | 6/9 | [1 −1]/[1 1] |

Table 2a below illustrates another example for CS and OCC assignment for maximum four layers. A single table may be used. Depending on the number of active layers, say k active layers, the first few rows or the first k rows in the table may be selected. For example if there are two layers for transmission, the first two rows are used for CS and/or OCC assignment. If there are four layers for transmission, the first four rows are used for CS and/or OCC assignment. By doing so, it is not necessary to have separate tables for different numbers of layers for transmission. A single table is sufficient. Note that the first two rows in the table below are a subset of table 1.

TABLE 2A
CS resources with OCC code assignments for
maximum four layer transmission

| DM-RS Index | CS | OCC |
|---|---|---|
| 0 | 0 | [1 1] |
| 1 | 6 | [1 −1] |
| 2 | 3 | [1 1] |
| 3 | 9 | [1 −1] |

Table 3 provides a non-limiting example of DM-RS indexes, CSs, and orthogonal cover codes for three layer transmission or a rank 3 transmission. DM-RS Index 0, 1 and 2 may map to CS 0, 4 and 8 with the same OCC=[1 1]. DM-RS Index 0, 1 and 2 may also map to CS 0, 4 and 8 with OCC=[1 1], [1 −1] and [1 1] respectively. DM-RS Index 0, 1 and 2 may also map to CS 0, 0 and 6 with OCC=[1 1], [1 −1] and [1 1] respectively. Other mappings or combinations are also possible and contemplated as within the scope of the present disclosure.

TABLE 3
CS resources with OCC code assignments for
three layer transmission (rank = 3)

| DM-RS Index | CS | OCC |
|---|---|---|
| 0 | 0 | [1 1] |
| 1 | 4/0 | [1 1]/[1 −1] |
| 2 | 8/6 | [1 1]/[1 1] |

Table 4 provides another non-limiting example of DM-RS indexes, CS indexes, and cover codes for three layer transmission or a rank 3 transmission. Alternatively, DM-RS indexes, CS indexes, and cover codes for three layer transmission or a rank 3 transmission may be defined as a subset of those for four layer transmission or a rank 4 transmission. It should be noted that the first CS, CS₀, is set to 0 in Tables 1, 2, 2a, 3, and 4, respectively. Alternatively, CS₀ may be any value, for example, between 0 and 11. Other CS(s) may then be configured/derived accordingly (e.g., CS₁=mod((CS₀+6),12) for two layer transmission (rank=2)). For a given rank, each entry of the DM-RS index/CS/OCC combinations in the corresponding table (e.g., Tables 1, 2, 2a, 3, or 4) may be mapped to the individual spatial layer (i.e., DM-RS antenna port) in a predefined manner.

TABLE 4
CS resources with OCC code assignments for
three layers transmission (rank = 3)

| DM-RS Index | CS | OCC |
|---|---|---|
| 0 | 0 | [1 1] |
| 1 | 3 | [1 −1] |
| 2 | 6 | [1 1] |

CS index and/or OCC index may also be used instead of CS or OCC for all the descriptions or examples above. In addition, explicit indication of OCC or OCC index used for DM-RS may also be possible. In such embodiments, OCC need not be linked with CS or CS index or a function of CS or CS index. For the use of OCC index OCC(j), j may be the index to the OCC. For example OCC index 0 or OCC(0) may be assigned for [+1 +1] and OCC index 1 or OCC(1) may be assigned for [+1 −1]. An OCC indicator may contain a single bit or more and be used for explicit indication of an OCC. If the OCC indicator is “0”, OCC(0) or [+1 +1] may be used. Otherwise OCC(1) or [+1 −1] may be used. An OCC indicator may be signaled via physical control channel (e.g., PDCCH), MAC layer signaling (e.g., MAC CE), or higher layer signaling (e.g., RRC signaling.) For example one bit may be inserted in downlink control information (DCI) format for uplink grant PDCCH. An OCC indicator may be used for each layer or antenna port or a group of layers or antenna ports. OCC indicators may also be used to indicate a set or a sequence of OCCs or OCC indices which may be predetermined or configured. For example if the OCC indicator is “0”, {OCC(0) OCC(0) OCC(0) OCC(0)} or {[+1 +1] [+1 +1] [+1 +1] [+1 +1]} may be used for the first, second, third and forth layers or antenna ports 0, 1, 2 and 3 respectively. If the OCC indicator is “1”, {OCC(0) OCC(1) OCC(0) OCC(1)} or {[+1 +1] [+1 −1] [+1 +1] [+1 −1]} may be used for the first, second, third and forth layers or antenna ports 0, 1, 2 and 3 correspondingly. This can be applied to any number of layers or antenna ports. Spare bit or code-point(s) may also be used to carry OCC indicator.

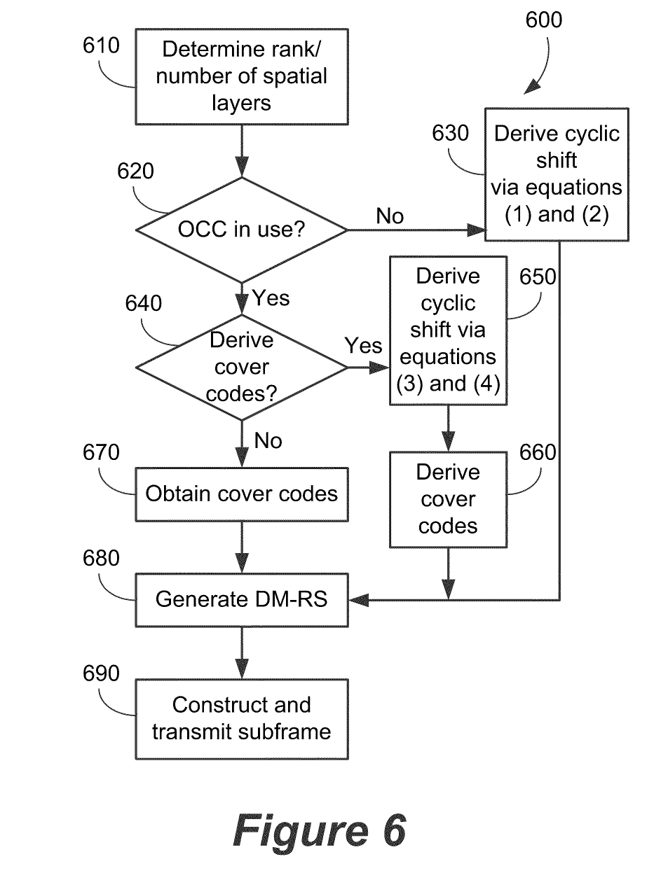

FIG. 6 illustrates a non-limiting exemplary method 600 of implementing the present subject matter. At block 610, a UE may receive from an eNodeB a rank indication for a channel or transmission or an indication of the number of spatial layers for which DM-RSs are needed. As noted above, this may be signaled or transmitted to a UE by a base station or eNodeB. At block 620, it may be determined whether OCC is in use. Note that in some embodiments, OCC may be configurable and/or defeatable by the eNodeB and thus may or may not be in use by a UE depending on the UE's current configuration. If OCC is not in use by the UE, at block 630 a cyclic shift may be derived by the UE using the methods set forth above for determining cyclic shift in systems that do not utilize OCC, and at block 680, a DM-RS may be generated for the RI indicated for use by the UE.

A channel (or transmission) rank indication (RI) may be received at a UE from a base station, such as an eNodeB. A rank indication (RI) may be signaled to the UE either by separate signaling, embedded in other control information or signal, or jointly coded with other control information such as transmission precoding matrix indication (TPMI). The received RI or determined rank may then be used to generate a cyclic shift (CS) offset, which may then be used to generate a CS. The generated cyclic shift may then be used to generate a demodulation reference signal to be used for uplink MIMO transmissions by the UE. Orthogonal Cover Codes (OCC) may be used in conjunction with a determined CS to generate a DM-RS.

If OCC is in use, at block 640, a determination may be made as to whether cover codes need to be derived or calculated, for example, using the equations and means described herein. If covers codes are to be derived, at block 650 a cyclic shift may be derived by the UE using the methods set forth above for determining cyclic shift in systems that utilize OCC. At block 660, cover codes may be derived by the UE and at block 680, a DM-RS may be generated by the UE using the derived cyclic shift and cover codes. In embodiments where cover codes are used but need not be derived, at block 670, cover codes may be obtained by the UE. Such cover codes may be obtained from fixed mappings that define CS/OCC combinations or from any other source. Regardless of whether OCC is in use or whether cover codes are to be derived or obtained, once a DM-RS is generated, a timeslot for a spatial layer may be constructed, or completed, at block 690 and the timeslot may be transmitted to a base station, eNodeB, or any other device via the rank-identified antenna or port.

In an embodiment, the CS for DM-RS antenna port m in a timeslot, nₛ, (denoted by n_{CS}(m, nₛ)), may be given by:

n_{CS}(m,nₛ)=(n_{DMRS}_{_{—}}₁+n_{DMRS}_{_{—}}₂(m)+n_{PRS}(nₛ))mod 12, where m=0,1,2, . . . , RI−1 (5)

where the values of n_{DMRS}_{_{—}}₁ is provided by higher layers, n_{DMRS}_{_{—}}₂(M) is equivalent to CSₘ described above such that CS₀ is signaled via PDCCH and other CSₘ may be derived based on CS₀ (using equations 1 and 2 or equations 3 and 4) or predefined. If CS₀ is not provided from PDCCH, then the value of CS₀ may be set to zero. n_{PRS}(nₛ) may be derived as the timeslot number by a predefined equation. In this embodiment, OCC may be turned off or fixed to either [1 1] or [1 −1] for the timeslots in a subframe. Alternatively, if OCC is on and/or is linked to the corresponding CS (or DM-RS antenna port), the CS for DM-RS antenna port m in a timeslot, nₛ, (denoted by n_{CS}(m, nₛ)), may be given by:

n_{CS}(m,nₛ)=(n_{DMRS}_{_{—}}₁+n_{DMRS}_{_{—}}₂(m)+n_{PRS}(nₛ))mod 12 for nₛε{0,2,4,6,8,10,12,14,16,18} (6)

for other nₛ (i.e., odd timeslots), n_{CS}(m, nₛ) is the same value as the CS calculated for the first timeslot within the same subframe using equation (6).

Note that any of the actions described in method 600 may be performed by a variety of devices or components. For example, generation of a DM-RS may be performed by a dedicated module, such as antenna mapping/precoding module 130 if UE 101 in FIG. 1, or alternatively by processor 140 of UE 101. Such actions may be performed locally on a UE or remotely and communicated to a UE via a wired or wireless communications link. Any other variation or configuration of components for performing any of the functions described herein is contemplated as within the scope of the present disclosure.

While the systems and methods for rank adaptive cyclic shift for demodulation reference signals have been described in connection with the various embodiments of the various figures, it is to be understood that other similar embodiments can be used or modifications and additions can be made to the described embodiments for performing the same function of providing generating DM-RSs without deviating therefrom. For example, one skilled in the art will recognize DM-RS generation systems and methods as described in the present application may apply to any environment and may be applied to any number of devices connected via a communications network and interacting across the network. Therefore, the presently disclosed DM-RS generation systems and methods should not be limited to any single embodiment, but rather should be construed in breadth and scope in accordance with the appended claims.

What is claimed is:

1. A wireless transmit and receive unit comprising:
a transceiver;
a plurality of antennas ports; and
a processor; wherein the processor is configured to determine a cyclic shift offset by:
determining a channel rank based on a rank indication for use by the wireless transmit and receive unit; and
determining the cyclic shift offset based on the channel rank.

2. The wireless transmit and receive unit of claim 1, wherein the processor is configured to determine a demodulation reference signal based on the cyclic shift offset.

3. The wireless transmit and receive unit of claim 1, wherein the processor is configured to determine a base demodulation reference signal.

4. The wireless transmit and receive unit of claim 3, wherein determining the cyclic shift offset based on the channel rank comprises determining the cyclic shift offset based on the channel rank and the base demodulation reference signal.

5. The wireless transmit and receive unit of claim 1, wherein the processor is configured to determine a cyclic shift based on the cyclic shift offset.

6. The wireless transmit and receive unit of claim 1, wherein determining the cyclic shift offset based on the channel rank comprises dividing a maximum cyclic shift by the cyclic shift rank.

7. The wireless transmit and receive unit of claim 1, wherein determining the cyclic shift offset based on the channel rank comprises determining the cyclic shift offset by dividing a maximum cyclic shift value by half of the channel rank.

8. The wireless transmit and receive unit of claim 1, wherein the processor is configured to determine that an orthogonal cover code is needed, and wherein determining the cyclic shift offset based on the channel rank comprises determining the cyclic shift offset based on the channel rank n and the determination that the orthogonal cover code is needed.

9. The wireless transmit and receive unit of claim 8, wherein the processor is configured to determine a cover code based on the channel rank.

10. The wireless transmit and receive unit of claim 9, wherein the processor is configured to determine a demodulation reference signal based on the cyclic shift offset and the cover code.

11. A method of using rank adaptive cyclic shift for demodulation reference symbols, the method comprising:
determining a channel rank based on a rank indication; and
determining a cyclic shift offset based on the channel rank.

12. The method of claim 11, wherein determining the cyclic shift offset based on the channel rank comprises dividing a maximum cyclic shift by the channel rank.

13. The method of claim 11, wherein determining the cyclic shift offset based on the channel rank comprises determining the cyclic shift offset by dividing a maximum cyclic shift value by half of the channel rank.

14. The method of claim 11, wherein determining the channel rank comprises determining the channel rank for a user equipment antenna port.

15. The method of claim 11, wherein determining the channel rank comprises determining that the channel rank is greater than one.

16. The method of claim 11, wherein determining the channel rank comprises determining that the channel rank is one, the method further comprising signaling the channel rank via a physical downlink control channel.

17. The method of claim 11, wherein determining the cyclic shift offset based on the channel rank comprises determining a first cyclic shift offset for a first layer based on the channel rank, and determining a second cyclic shift offset for a second layer based on the first cyclic shift offset.

18. The method of claim 17, wherein determining the cyclic shift offset based on the channel rank comprises determining a third cyclic shift offset for a third layer based on the first cyclic shift offset.

19. The method of claim 18, wherein determining the cyclic shift offset based on the channel rank comprises determining a fourth cyclic shift offset for a fourth layer based on the first cyclic shift offset.

20. The method of claim 11, further comprising determining that an orthogonal cover code is needed, and wherein determining the cyclic shift offset based on the channel rank comprises determining the cyclic shift offset based on the channel rank and the determination that the orthogonal cover code is needed.
